(19) United States
(12) Patent Application Publication
(10) Pub. No.: US 2015/0369988 A1
(43) Pub. Date: Dec. 24, 2015

(54) BACKLIGHT MODULE AND DISPLAY DEVICE

(71) Applicant: Ye Xin Technology Consulting Co., Ltd., Hsinchu (TW)

(72) Inventors: CHIA-YU HSU, Hsinchu (TW); LI-CHIAO HUANG, Hsinchu (TW); PEI-CHUN TSAI, Hsinchu (TW)

(21) Appl. No.: 14/567,335

(22) Filed: Dec. 11, 2014

(30) Foreign Application Priority Data
Jun. 20, 2014 (TW) 103121479

(51) Int. Cl. F21V 8/00; G02F 1/1335

(52) U.S. Cl. CPC G02B 6/004; G02B 6/0026; G02B 6/005; G02B 6/0031; G02F 1/1336; G02F 2001/133614

(57) ABSTRACT

The disclosure provides a backlight module and a display device with a backlight module. The backlight module includes an emitting element, phosphors, and a quantum dot film. The emitting element is configured to provide lights with a first primary color. The phosphors have a second primary color. The quantum dot film includes numbers of quantum dots configured to provide emission spectrum with a third primary color. The light from the emitting element excites the phosphors and the quantum dot film to generate white mixed light.

### FIELD

The present disclosure relates to a backlight module and more particularly, to a display device with a backlight module.

### BACKGROUND

A liquid crystal display (LCD) does not emit light and hence requires a backlight for its function as a visual display. Recently, Light Emitting Diodes (LEDs) have been employed as light sources for backlighting LCDs. However, the LED's color gamut is not so good, the backlight module and the display device exist the problem that the color gamut and transmittance of light are not high, thereby reducing the display effect.

### SUMMARY

In an exemplary embodiment, a backlight module includes an emitting element, phosphors, and a quantum dot film. The emitting element is configured to provide a light with a first primary color. The phosphors have a second primary color. The quantum dot film includes numbers of quantum dots configured to provide an emission spectrum with a third primary color. The light from the emitting element excites the phosphors and the quantum dot film to generate white light.

### BRIEF DESCRIPTION OF THE DRAWINGS

Implementations of the present technology will now be described, by way of example only, with reference to the attached figures.

FIG. 1 illustrates a diagram of an emission spectrum emitted by a backlight module.

FIG. 2 illustrates a diagram of an emission spectrum emitted by another backlight module.

FIG. 3 illustrates a diagram of an emission spectrum emitted by a backlight module.

FIG. 4 illustrates a diagram of an emission spectrum emitted by another backlight module.

FIG. 5 is an exploded, isometric view of a first embodiment of a display device of the present disclosure.

FIG. 6 is an assembled isometric view of a first embodiment of a display device of the present disclosure.

FIG. 7 is a cross-sectional view of the display device of the present disclosure.

FIG. 8 is a cross-sectional view of a second embodiment of a display device of the present disclosure.

FIG. 9 is a cross-sectional view of a third embodiment of a display device of the present disclosure.

FIG. 10 is a cross-sectional view of a fourth embodiment of a display device of the present disclosure.

FIG. 11 is a cross-sectional view of a fifth embodiment of a display device of the present disclosure.

FIG. 12 is a cross-sectional view of a sixth embodiment of a display device of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

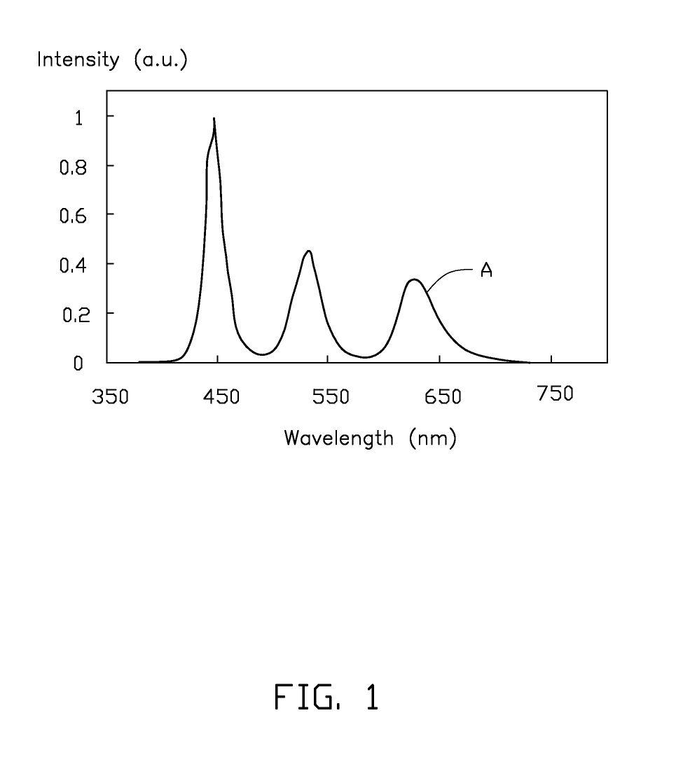

In order to achieve high color gamut of light from the backlight module and the display device, there is providing a backlight module and a display device. The backlight module includes a light guide plate, a blue light emitting diode chip disposed beside the light guide plate, and a quantum dot film with red and green emission spectra that is disposed above the light guide plate. The blue light from the blue light emitting diode chip is provided to the quantum dot film through the light guide plate. The blue light excites the quantum dot film to generate the red light and the green light, and white mixed light is formed according to the blue light, the red light, and the green light. However, due to the quantum dot film has the red and green emission spectra, which means there are two different sizes red quantum dots and green quantum dots therein. Therefore, the process of manufacturing the quantum dot film is complicated, and the thickness of the quantum dot film is large, which causes that the thickness of the backlight module and the display device are reduced difficulty and the brightness of the backlight module and the display device are also decreased. FIG. 1 illustrates a diagram of an emission spectrum emitted by a backlight module. In FIG. 1, curve A shows that the intensity of the backlight module needs to be enhanced (especially the intensity between the wavelengths of 600 nm to 700 nm).

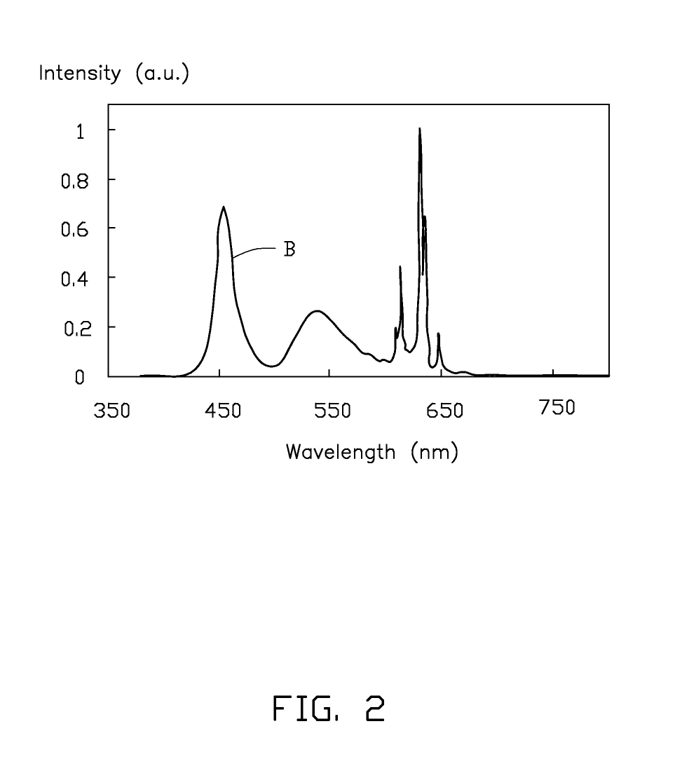

In order to achieve high color gamut of light from a backlight module and a display device and reducing the thickness of the backlight module, there is providing a backlight module and a display device. The backlight module includes blue light emitting diode chip and red phosphors and green phosphors. The red phosphors and the green phosphors are covering the blue light emitting diode chip. The blue light excites the red phosphors and the green phosphors to generate white light. However, in this case, the intensity and the brightness of the backlight module also need to be enhanced. FIG. 2 illustrates a diagram of an emission spectrum emitted by the backlight module. In FIG. 2, curve B shows that the intensity of the backlight module needs to be enhanced (especially the intensity between the wavelengths of 500 nm to 600 nm).

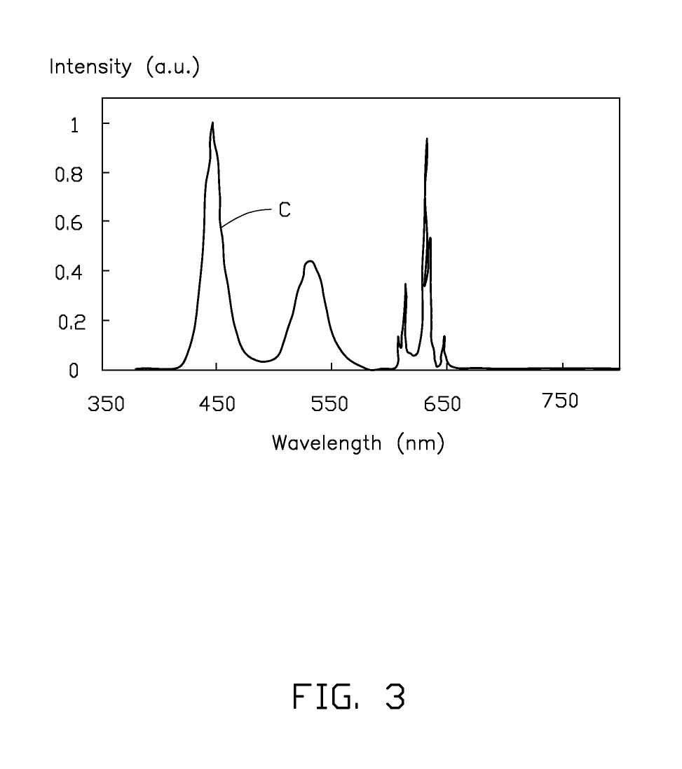

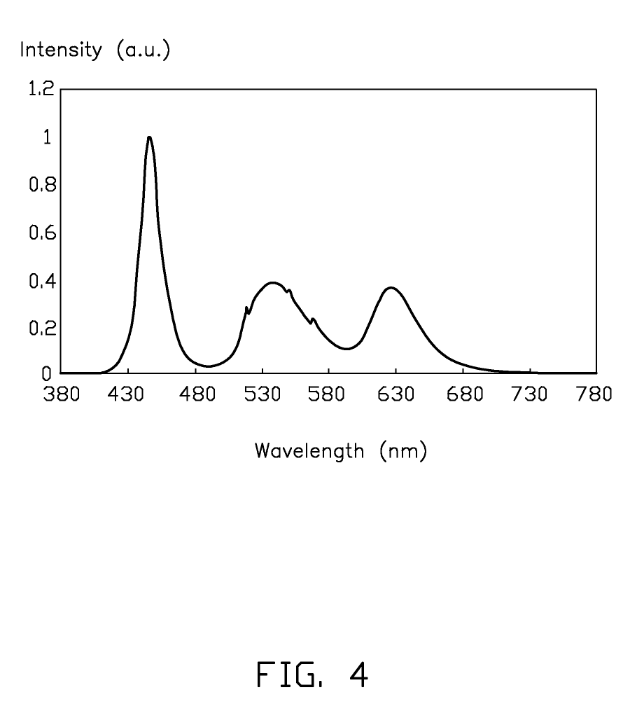

In order to achieve high color gamut of light from a backlight module and a display device and reducing the thickness of the backlight module, there is providing a backlight module and a display device. The backlight module includes an emitting element, phosphors, and a quantum dot film. The emitting element is configured to provide light with a first primary color. The phosphors have a second primary color. The quantum dot film includes numbers of quantum dots configured to provide emission spectrum with a third primary color. The lights from the emitting element stimulate the phosphors and the quantum dot film to generate white mixed light. That is, the backlight module emits white light by the light from the emitting element stimulating the phosphors and the quantum dot film. The quantum dots have the characteristics of good light stability and long fluorescence lifetime, which increases the color gamut of lights from the backlight module and the display device. These features also satisfy the requirement for the light sources of the backlight module, and the display effect can be improved. Furthermore, the size of each quantum dots required in the quantum dot film can be the same, and the thickness of the whole backlight module with the quantum dot film is decreased. Thin quantum dot film has high transmittance such that the intensity and the brightness of the backlight module are enhanced. In at least one embodiment, the first primary color is blue, the second primary color is red, and the third primary color is green. FIG. 3 illustrates a diagram of an emission spectrum emitted by the backlight module. In FIG. 3, curve C shows that the color gamut is improved and the intensity and the brightness are enhanced. In another embodiment, the first primary color is blue, the second primary color is green, and the third primary color is red. FIG. 4 illustrates a diagram of an emission spectrum emitted by the backlight module. In FIG. 4, curve D shows that the color gamut is improved and the intensity and the brightness are enhanced.

In order to achieve high color gamut of light from a display device and reducing the thickness of a backlight module, there is providing a display device. The display device includes a display panel, an emitting element, phosphors, and a quantum dot film. The emitting element is configured to provide lights with a first primary color. The phosphors have a second primary color. The quantum dot film includes numbers of quantum dots configured to provide emission spectrum with a third primary color. The lights from the emitting element stimulate the phosphors and the quantum dot film to generate white mixed light, providing to the display panel for display. The quantum dots have the characteristics of good light stability and long fluorescence lifetime, which increases the color gamut of lights from the backlight module and the display device. These features also satisfy the requirement for the light sources of the backlight module, and the display effect can be improved. Furthermore, the size of each quantum dots required in the quantum dot film can be the same, and the thickness of the whole backlight module with the quantum dot film is decreased. Thin quantum dot film has high transmittance such that the intensity and the brightness of the backlight module are enhanced.

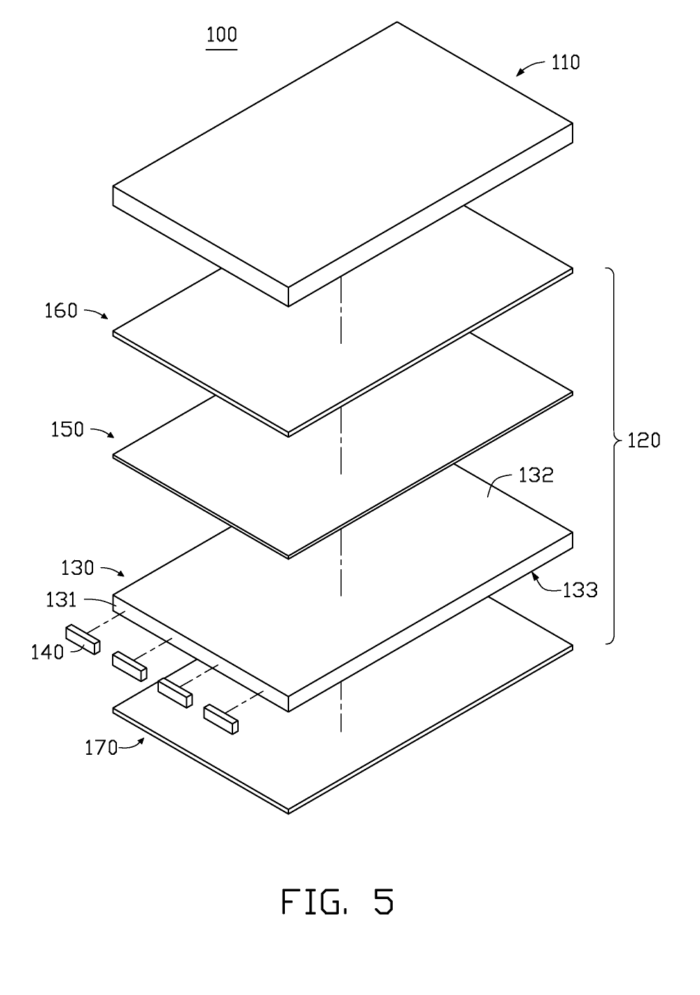

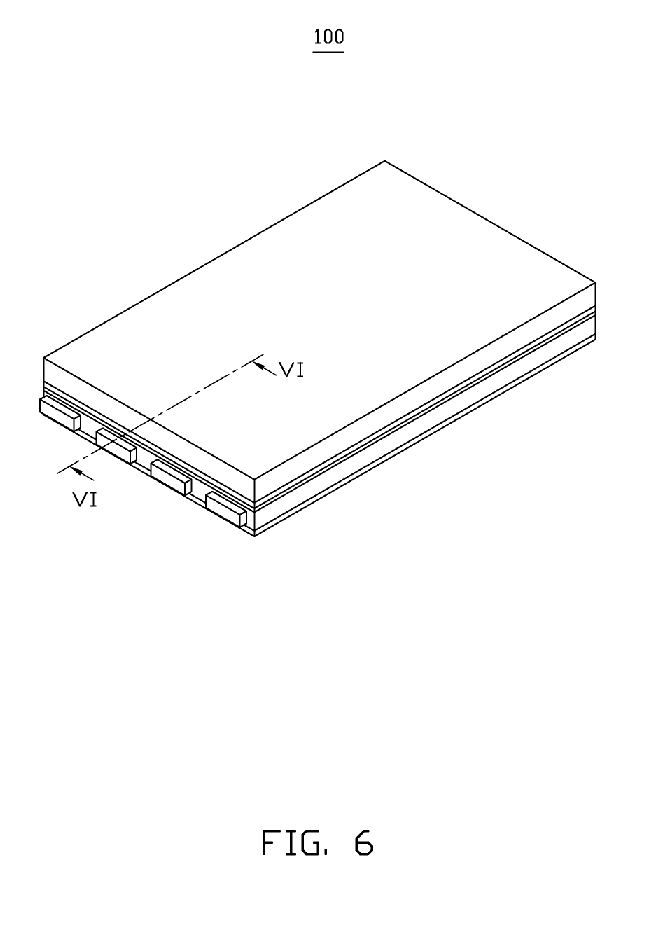

FIG. 5 illustrates an exploded isometric view of a first embodiment of a display device 100 of the present disclosure. FIG. 6 illustrates an assembled isometric view of a first embodiment of a display device 100 of the present disclosure. The display device 100 includes a display panel 110, and a backlight module 120 disposed under the display panel 110. The backlight module 120 provides white plane light required by the display panel 110. The display panel 110 may be a liquid crystal display panel. The backlight module 120 includes a light guide plate 130, a light source 140, a quantum dot film 150, an optical film 160, and a reflector 170.

The light guide plate 130 has a light incident surface 131, a light emitting surface 132 adjacent to the light incident surface 131, and a bottom surface 133 opposite to the light emitting surface 132. The light source 140 is disposed beside the light incident surface 131, the quantum dot film 150 is disposed beside the light emitting surface 132, and the reflector 170 is disposed beside the bottom surface 133. The optical film 160 is disposed beside the quantum dot film 150 away from the light guide plate 130 and sandwiched between the quantum dot film 150 and the display panel 110.

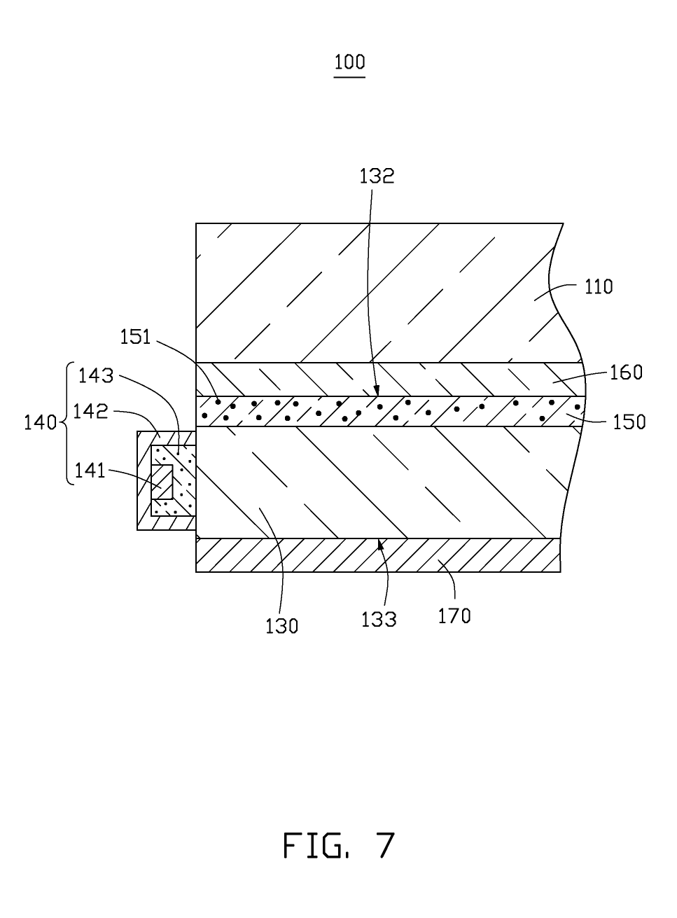

FIG. 7 illustrates a cross-sectional view of the display device 100 of the present disclosure. In at least one embodiment, the light source 140 may be a light emitting diode comprising a package body 142, an emitting element 141 fixed in the package body 142, and phosphors 143 distributed in the package body 142 and covering the emitting element 141. The emitting element 141 is configured to provide light with a first primary color. In at least one embodiment, the emitting element 141 may be a blue light emitting diode chip, and the first primary color is blue. The phosphors 143 and the emitting element 141 are integrally formed. The phosphors 143 may cover directly on the emitting element 141 or may be disposed in the package body 142, such that the light from the emitting element 141 emits outwardly through the phosphors 143. In this embodiment, the phosphors 143 may have a second primary color. The second primary color may be red. In other words, the phosphors 143 may be red phosphors. The red phosphor material may comprise Mn4+ or Eu2+, such as Ca2Si5N8:Eu2+, Sr2Si5N8:Eu2+, Ca2AlSiN3:Eu2+, CaS:Eu2+, Mg2TiO4:Mn4+, and K2TiF6:Mn4+, etc. Parts of the lights with the first primary color from the emitting element 141 excite the phosphors 143 to generate lights with the second primary color. The lights with the second primary color mix with the other parts of the light with the first primary color from the emitting element 141 such that the light source 140 emits a mixed light of the first primary color and the second primary color. In one embodiment, the emitting element 141 may be a blue light emitting diode chip, the phosphors 143 may be red phosphors, and the light source 140 emits a mixed light of blue light and red light.

The mixed light of the first primary color and the second primary color emitting from the light source 140 passes through the light incident surface 131 into the light guide plate 130 and leaves the light guide plate 130 through the light emitting surface 132, outwardly emitting. The mixed light emitting from the light emitting surface 132 of the light guide plate 130 is provided to the quantum dot film 150. The reflector 170 reflects light leaking from the bottom of the light guide plate 130 back to the light guide plate 130.

The quantum dot film 150 has a plurality of quantum dots, providing light of third primary color emission spectrum. The mixed light mentioned above further excites the quantum dot film 150 to generate white light. The first primary color, the second primary color, and the third primary color are different, each respectively a monochrome color. In at least one embodiment, the third primary color may be green. In other words, the quantum dot film 150 has a plurality of quantum dots 151 with green emission spectrum. Preferably, the size of the quantum dots 151 in the quantum dot film 150 is the same, which means, the quantum dots 151 in the quantum dot film 150 has only one size (has only one emission spectrum). Particularly, the size (diameter) of the quantum dots 151 is in the range of 2.5 nm to 3 nm, and the material thereof comprises CdSe or ZnO. The mixed light emitting from the light emitting surface 132 of the light guide plate 130 is provided to the quantum dot film 150. Some of the mixed lights excite the quantum dots 151 to generate lights with the third primary color, and other of the mixed lights remix with the lights with third primary color to generate white light which is emitting outwardly from the quantum dot film 150. A white plan light is provided to the display panel 110 from the quantum dot film 150 through an optical film.

The optical film 160 may be a diffuser or a brightness enhancement film. In at least one embodiment, the optical film may not be required. The white plane light from the quantum dot film 150 may directly emit toward the display panel 110.

The backlight module 120 generates white light by the light of the emitting element 141 exciting the phosphors 143 and the quantum dot film 150. Due to the quantum dots 151 have the characteristics of good light stability and long fluorescence lifetime that increasing the color gamut of lights from the backlight module 120 and enhancing the color gamut of lights of the backlight module 120 and the display device 100 (shown in FIG. 3 as curve C), which also meets the requirement for the light sources of the backlight module, display effect can be improved. Furthermore, size of each quantum dots 151 in the quantum dot film 150 may be the same, then the fabrication and the structure of the quantum dot film 150 is easy, and the thickness of the whole backlight module 120 with the quantum dot film 150 is decreased. Thin quantum dot film 150 has high transmittance such that the intensity and the brightness of the backlight module 120 are enhanced (shown in FIG. 3 as curve C).

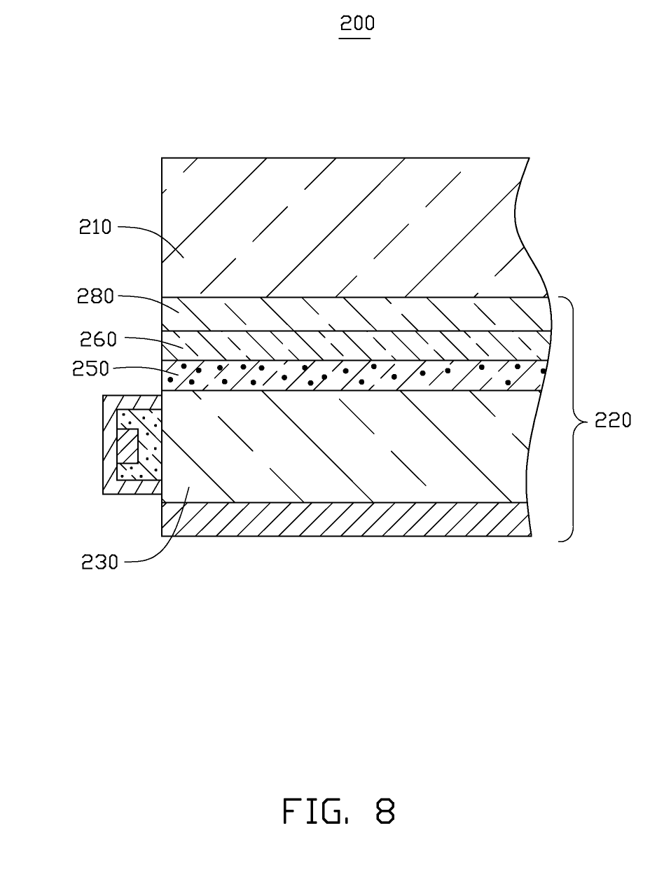

FIG. 8 illustrates a cross-sectional view of a second embodiment of a display device 200 of the present disclosure. The display device 200 includes a display panel 210, and a backlight module 220 disposed under the display panel 210. The display device 200 is similar to the display device 100 of the first embodiment but the display device 200 comprises two optical films 260 and 280. The optical film 260 and the optical film 280 are disposed on the quantum dot film 250 away from the light guide plate 230 and sandwiched between the display panel 210 and the quantum dot film 250. Each of the optical film 260 and the optical film 280 may be a diffuser or a brightness enhancement film.

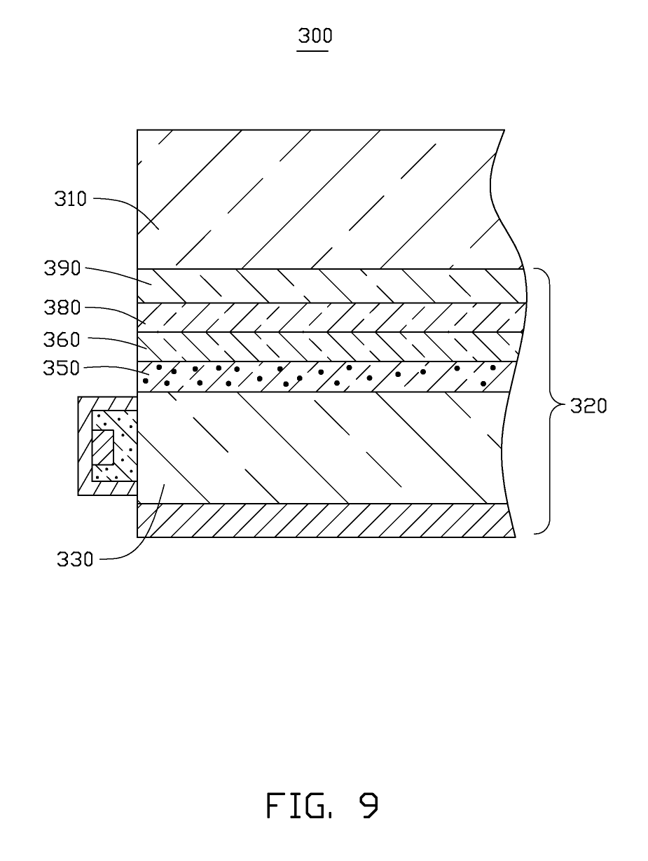

FIG. 9 illustrates a cross-sectional view of a third embodiment of a display device 300 of the present disclosure. The display device 300 includes a display panel 310, and a backlight module 320 disposed under the display panel 310. The display device 300 is similar to the display device 100 of the first embodiment but the display device 300 comprises three optical films 360, 380 and 390. The optical film 360, the optical film 380 and the optical film 390 are disposed on the quantum dot film 350 away from the light guide plate 330 and sandwiched between the display panel 310 and the quantum dot film 350. Each of the optical film 360, the optical film 380 and the optical film 390 may be a diffuser or a brightness enhancement film.

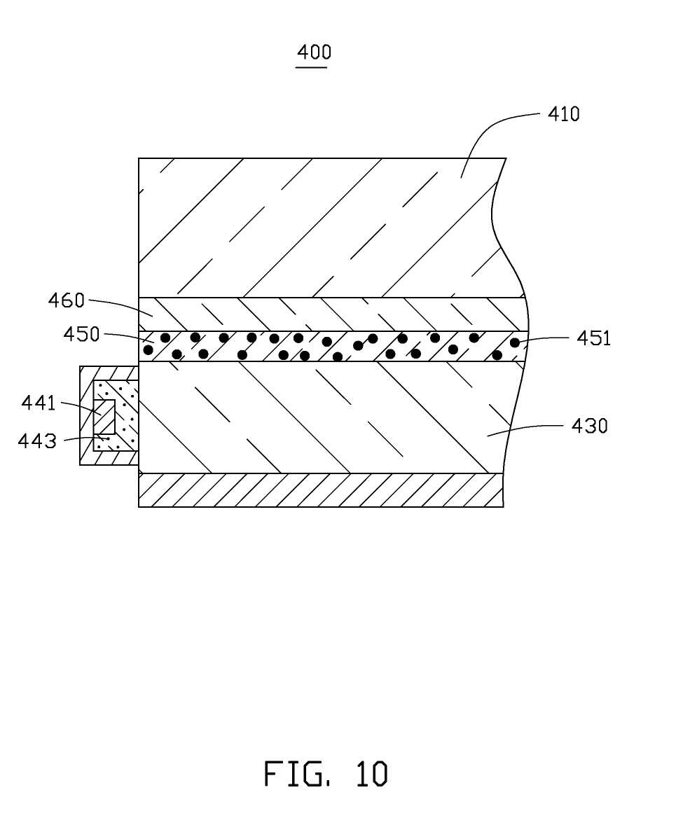

FIG. 10 illustrates a cross-sectional view of a fourth embodiment of a display device 300 of the present disclosure. The display device 400 is similar to the display device 100 of the first embodiment but phosphors 443 and a quantum dot film 450 of the fourth embodiment are different from the phosphors 143 and the quantum dot film 150 of the first embodiment. In the fourth embodiment, the second primary color may be green, and the third primary color may be red. In other words, the phosphors 443 may be green phosphors. The green phosphor material may comprise Eu2+ or Ce3+, such as (Ba,Sr)2SiO4:Eu2+, Lu3AL5o12:Ce3+, SrSi2N2O2:Eu2+, or SrGa2S4, etc. The quantum dot film 450 has a plurality of quantum dots 451 providing lights with red emission spectrum. Size of each quantum dot 451 in the quantum dot film 450 is the same, and different from the size of the quantum dot 151 in the first embodiment. Particularly, the size (diameter) of the quantum dots 451 is in the range of 5 nm to 6 nm, and the material thereof comprises CdSe or ZnO.

In the fourth embodiment, blue lights from the emitting element 441 through the green phosphors 443 to generate mixed light of blue light and green light. The mixed light of blue light and green light passes through the light guide plate 430 and be providing to the quantum dot film 450. Parts of the mixed lights of blue light and green light stimulate the quantum dots 451 to generate red light. The other of the mixed lights of blue light and green light mix with the red light to generate white light emitting from the quantum dot film 450. The quantum dot film 450 may provide planar white light through the optical film 460 toward the display device 410. As shown in FIG. 4, the color gamut and the brightness of the backlight module of this embodiment are enhanced.

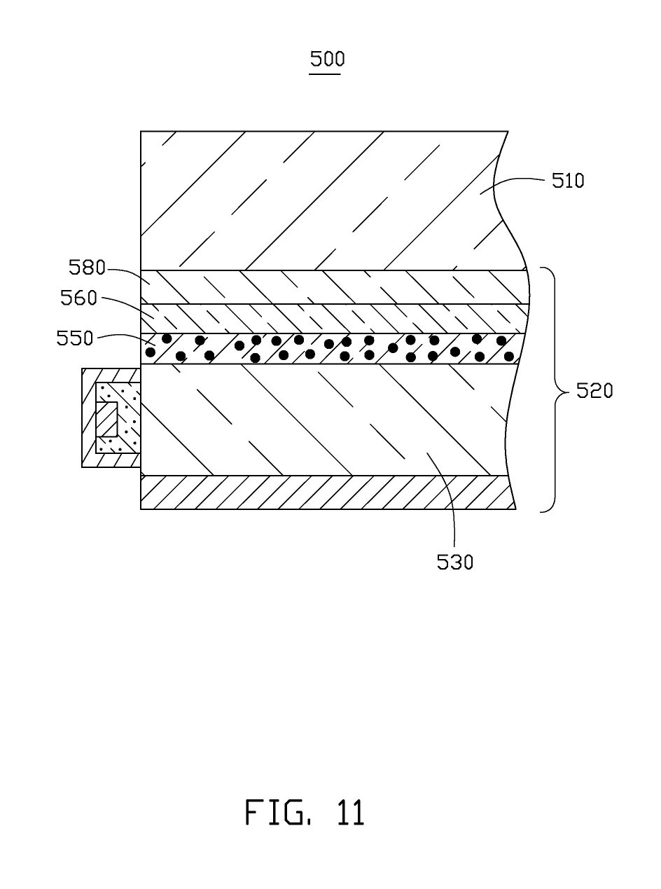

FIG. 11 illustrates a cross-sectional view of a fifth embodiment of a display device 500 of the present disclosure. The display device 500 includes a display panel 510, and a backlight module 520 disposed under the display panel 510. The display device 500 is similar to the display device 400 of the fourth embodiment but the display device 500 comprises two optical films 560 and 580. The optical film 560 and the optical film 580 are disposed on the quantum dot film 550 away from the light guide plate 530 and sandwiched between the display panel 510 and the quantum dot film 550. Each of the optical film 560 and the optical film 580 may be a diffuser or a brightness enhancement film.

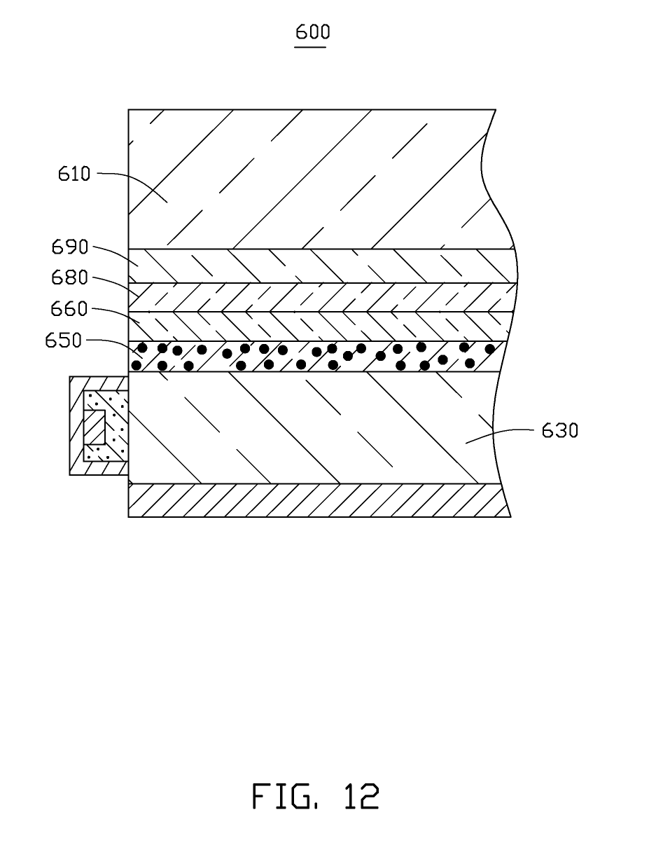

FIG. 12 illustrates a cross-sectional view of a sixth embodiment of a display device 600 of the present disclosure. The display device 600 is similar to the display device 400 of the fourth embodiment but the display device 600 comprises three optical films 660, 680 and 690. The optical film 660, the optical film 680 and the optical film 690 are disposed on the quantum dot film 650 away from the light guide plate 630 and sandwiched between the display panel 610 and the quantum dot film 650. Each of the optical film 660, the optical film 680 and the optical film 690 may be a diffuser or a brightness enhancement film.

The embodiments shown and described above are only examples. Many details are often found in the art such as the other features of a backlight module or a display device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A backlight module, comprising:
an emitting element for providing a light with a first primary color;
phosphors having a second primary color; and
a quantum dot film including a plurality of quantum dots for providing an emission spectrum with a third primary color,
wherein the light from the emitting element stimulates the phosphors and the quantum dot film to generate white light.

2. The backlight module of claim 1, wherein the first primary color, the second primary color, and the third primary color are different, respectively red, green, and blue.

3. The backlight module of claim 1, wherein the emitting element comprises a blue light emitting diode chip, the phosphors comprise red phosphors, and the plurality of quantum dots comprises a plurality of quantum dots with green emission spectrum.

4. The backlight module of claim 1, wherein the emitting element comprises a blue light emitting diode chip, the phosphors comprise green phosphors, and the plurality of quantum dots comprises a plurality of quantum dots with red emission spectrum.

5. The backlight module of claim 1, wherein the size of the plurality of quantum dots contained in the quantum dot film is the same.

6. The backlight module of claim 1, wherein the emitting element and the phosphors are integrally packaged to form a light source of the backlight module, and the light source emits a mixed light of the first primary color and the second primary color.

7. The backlight module of claim 1, further comprising a light guide plate, wherein the light guide plate comprises a light incident surface, a light emitting surface adjacent to the light incident surface, and a bottom surface opposite to the light emitting surface, the emitting element is disposed beside the light incident surface, the phosphors are disposed between the light source and the light incident surface, and the quantum dot film is disposed on the light emitting surface.

8. The backlight module of claim 7, further comprising a reflector and an optical film, wherein the reflector is disposed on the bottom surface, and the optical film is disposed on the quantum dot film away from the light guide plate.

9. The backlight module of claim 8, wherein the optical film comprises a diffuser or a brightness enhancement film.

10. A display device comprising:
a display panel;
an emitting element for providing a light with a first primary color;
phosphors having a second primary color; and
a quantum dot film including a plurality of quantum dots for providing an emission spectrum with a third primary color,
wherein the light from the emitting element stimulates the phosphors and the quantum dot film to generate white light required by the display panel.

11. The display device of claim 10, wherein the display panel comprises a liquid crystal display panel.

12. The display device of claim 10, wherein the first primary color, the second primary color, and the third primary color are different, respectively red, green, and blue.

13. The display device of claim 10, wherein the emitting element comprises a blue light emitting diode chip, the phosphors comprise red phosphors, and the plurality of quantum dots comprises a plurality of quantum dots with green emission spectrum.

14. The display device of claim 10, wherein the emitting element comprises a blue light emitting diode chip, the phosphors comprise green phosphors, and the plurality of quantum dots comprises a plurality of quantum dots with red emission spectrum.

15. The display device of claim 10, wherein the size of the plurality of quantum dots contained in the quantum dot film is the same.

16. The display device of claim 10, wherein the emitting element and the phosphors are integrally encapsulated to form a light source of the display device, and the light source emits a mixed light of the first primary color and the second primary color.

17. The display device of claim 16, wherein the quantum dot film is disposed above the display panel for providing a uniform white plane light toward the display panel.

18. The display device of claim 10, further comprising a light guide plate, wherein the light guide plate comprises a light incident surface, a light emitting surface adjacent to the light incident surface, and a bottom surface opposite to the light emitting surface, the emitting element is disposed beside the light incident surface, the phosphors are disposed between the light source and the light incident surface, and the quantum dot film is disposed on the light emitting surface.

19. The display device of claim 18, further comprising a reflector and an optical film, wherein the reflector is disposed on the bottom surface, and the optical film is disposed on the quantum dot film away from the light guide plate.

20. The display device of claim 19, wherein the optical film comprises a diffuser or a brightness enhancement film.
